(19) United States
(12) Patent Application Publication
(10) Pub. No.: US 2018/0253760 A1
(43) Pub. Date: Sep. 6, 2018

(54) INTERACTIVE ELECTRONIC MAP

(71) Applicant: Seth TENKORANG, Detroit, MI (US)

(72) Inventor: Seth TENKORANG, Detroit, MI (US)

(21) Appl. No.: 15/907,533

(22) Filed: Feb. 28, 2018

Related U.S. Application Data
(60) Provisional application No. 62/600,759, filed on Mar. 2, 2017.

(51) Int. Cl. G06Q 30/02; G06F 17/30

(52) U.S. Cl. CPC G06Q 30/0261; G06F 17/30867; G06F 17/3087; G06F 17/30241

(57) ABSTRACT

An interactive, user-friendly electronic map, which may be provided as a graphical user interface, and a device for displaying same, which may be provided in the form of a display stand or kiosk fixed in a certain location. The interactive electronic map may have multiple views, each geared toward displaying mapping information that is narrowly tailored to displaying, specifically, a selected type of content. In one example, an interactive electronic map may have a first button that, when pressed, specifically shows all restaurants in the area and only that mapping information that would allow a user to reach each displayed restaurant, and a second button that, when pressed, shows all street information for the area.

### CROSS-REFERENCE TO RELATED APPLICATIONS

This application claims priority from U.S. Provisional Patent Application No. US 62/600,759, filed on Mar. 2, 2017, entitled “INTERACTIVE ELECTRONIC MAP,” the entire contents of which are hereby incorporated by reference.

### BACKGROUND

Visual artists, architects, and designers have long understood the principle that “less” is often “more,” Many forms of art, including architecture, interior design, industrial design, painting, and music, have periodically emphasized the use of simplicity, negative space, and function over form.

Often, this has been regarded as an aesthetic choice, or one motivated by cultural factors. For example, Japanese traditional culture emphasizes balance and simplicity, which has bled over into its art and architecture. As such, these have long employed minimalist aspects, emphasizing simple colors and design choices that promote functionality and a sense of calm. Western designers, too, have adopted similar design philosophies; the IKEA furniture company is famous for its simple, easy-to-use designs which do away with excess ornamentation entirely in favor of solid, clean lines.

Such design philosophies have not been limited to physical art; minimalism has often influenced the design of software interfaces, such as graphical user interfaces for websites. GOOGLE's website famously includes little more than its cheery six-character logo surrounded by a clean, white background, and, of course, a search bar.

However, minimalism has functional goals as well as aesthetic ones, which are often neglected by artists who regard it as a mere aesthetic choice. Minimalism ultimately emphasizes usability and economy, the ability to do more with less. Sites like GOOGLE's have appeal not just because of their aesthetic impact but because they are not awash in unnecessary animations, slow-loading Flash intros, and script-heavy menu functions prone to browser compatibility issues. The proper use of negative space can help keep information from overwhelming users and draw users' attention to important information or important functional elements. By removing elements that are not necessary to the goal of the software or of the web page, designers can ensure that users have a less stressful and more engaging experience, in which they will have to spend less time searching for the features that they need.

### SUMMARY

However, while graphical user interface designers have adopted minimalist principles for some websites, by and large the functional considerations are secondary to the aesthetic ones, and as such the vast majority of websites and the vast majority of software graphical user interfaces are filled with unnecessary decorative elements and informational noise. For example, informational interfaces, like maps, have not seen the benefit of minimalist construction, because it is believed that the information presented therein does not represent a distracting excess of information. However, often, this is not so; many users, particularly tourists or visitors to an area, can be overwhelmed by excess information, when most of the time users (particularly visitors or tourists) are interested in going to the same places as other tourists or visitors typically go to.

According to an exemplary embodiment, an interactive electronic map and a display device configured to show the same as a graphical user interface may be disclosed. The interactive electronic map may, in some exemplary embodiments, have the function of displaying maps having a specific purpose or which specifically concern a particular names area or place. In some exemplary embodiments, the display device may be configured such that it shows only the desired map with points of interest, or a location and path, to the user. The interactive electronic map may be configured to hide undesired objects and other undesirable information on the map. This may serve to make maps significantly more user-friendly. The narrow tailoring of the interactive electronic map to a specific purpose may also be used for marketing and advertising purposes. For example, it can be used for business promotion in a user-desired area, in a manner that may be used to make advertising much more effective by ensuring that only a few businesses (such as businesses actually within the area) are advertised. For example, according to an exemplary embodiment, an interactive electronic map may be configured to detect when it is not in use or has not been used for some time, and may enter a dormant state in which it displays one or more advertisements. In some exemplary embodiments, the display of mapping information and the display of advertisements may be mutually exclusive, while in other exemplary embodiments they may be shown together or through different media (for example, an audio advertisement may play when the user is accessing a map). In this manner, the interactive electronic map may make improvements over prior art mapping interfaces, and in particular may ensure that a user does not have to drill down through many layers of map in order to get to desired data, by ensuring that selected data of interest is immediately displayed, allowing the user to see places that are most relevant to most visitors and how to navigate to them without requiring the user to conduct extensive searching. This saves the user from having to navigate to some application, open it up, and then navigate within that application in order to enable the data of interest to be seen.

According to an exemplary embodiment in which the interactive electronic map is configured to display a particular area, the advertisements hosted by the interactive electronic map (if any) may be limited to those businesses in the particular area, or which are in some way associated with the particular area. For example, a large restaurant chain that has franchise locations in the particular area may be eligible to advertise (having locations in the particular area) or may not be eligible to advertise (because it is not unique to the particular area or primarily concentrated in the particular area). In another example, a political action committee supporting a politician who is running for a political position associated with a geographical area falling within or overlapping the particular area (for example, a local council member or a member of the U.S. House of Representatives) may be eligible to advertise. In some exemplary embodiments, prospective advertising messages may be associated with priority information such that certain advertising messages of a higher priority or other messages of a higher priority may be selected by the interactive electronic map for display when idle more often, and such that certain advertising messages of a lower priority or other messages of a lower priority may be selected by the interactive electronic map for display when idle less often. According to an exemplary embodiment, priority information may be based on, for example, the existence of a business in an area or the degree of association the business has with the area, so as to ensure that, for example, advertisements for businesses within the particular area are displayed or are more likely to be displayed, while advertisements for businesses outside of the particular area or with primary operations outside of the particular area are not displayed or are less likely to be displayed. In some exemplary embodiments, priority information may be changed based on a physical location of the user when they access the interactive electronic map, such that local businesses are of a much higher priority and businesses in other areas are at a lower priority or are removed entirely.

According to an exemplary embodiment, an interactive electronic map may specifically be configured in a display device, such as a display terminal or kiosk, which may store a certain number of pre-saved maps which may be made available immediately at the touch of a button. According to an exemplary embodiment, each of the pre-saved maps may be associated with a particular location of interest around a city, town, or other site, such as a large building, a theme park, a cruise ship, or any other site where it may be appropriate to install one.

According to an exemplary embodiment wherein multiple interactive electronic map display devices are installed at particular vantage points within a locality, the interactive electronic map display devices may be controlled by a central server or central server cluster. (For example, in an exemplary embodiment in which interactive electronic map display devices are placed throughout a metropolitan area having multiple neighborhoods or boroughs, the metropolitan area may have a single central server for all of the interactive electronic map display devices or may have multiple servers dispersed throughout the metropolitan area; it may also be contemplated that each metropolitan area may not specifically have a dedicated server, and all interactive electronic map information for a number of locations may be stored at one centralized server or set of servers) According to an exemplary embodiment, an administrator may be provided with access to the server or set of servers (which may, for example, be or limited access to the one or more servers) and may be able to install, delete, or edit maps such as may be desired, in order to add new maps, remove old maps, or edit existing maps to show different places (for example, new restaurants that have opened) or edit the details provided about existing places, such as may be desired. According to an exemplary embodiment, an administrator may be able to directly or indirectly load advertisements through accessing the server, such as may be desired.

According to an exemplary embodiment, an interactive electronic map display device may be configured to implement a method for generating an electronic map displayed in a graphical user interface, which may include a step of displaying, on a first screen of the graphical user interface, unaltered mapping information (such as a “streets” map), the unaltered mapping information corresponding to a specific are (such as, for example, a certain geographical radius around the physical location of an interactive electronic map display device). The device may further be configured to store a plurality of places of interest (which may not necessarily be all of the places of interest in the area, and may, for example, be only places of interest that advertise), each stored place of interest being associated with one or more categories of place of interest, each stored place of interest being located within the specific area.

The device may receive a user input comprising at least one user selection, with this user selection being at least one of a selected place of interest or a selected category of places of interest, and further being associated with a user location. (For example, it may come from a fixed-location terminal.) This may result in the selection of at least one same-category place of interest (which may be either in the same category as a location the user has selected, or may be in the category the user has selected). In some exemplary embodiments, the user may also be able to clear this selection, which may restore the unaltered mapping data, or may make other modifications such as may be desired.

The device may further select navigation information including at least one navigable path between the user location and the at least one user selection, and at least one navigable path between the user location and the at least one same-category place of interest, which may be used to narrow down the roads that are actually shown to the user. The device may further display, on a second screen of the graphical user interface, altered mapping information consisting of the at least one same category place of interest and the selected navigation information, and may remove extraneous mapping information.

In an exemplary embodiment, the graphical user interface may be returned to normal automatically once a user input has been cleared. This may, for example, be configured to take place once the interactive electronic map is detected to not be in use (for example, if a sensor, such as an IR sensor or camera, detects that no one is standing directly in front of an interactive electronic map display device) or if the interactive electronic map is assumed to not be in use (for example, if the interactive electronic map display device has been left dormant for some specific period of time, such as, for example, 5-10 seconds or any other such period of time, it may be assumed that the user has left).

In an exemplary embodiment, the graphical user interface may be implemented on a display device with buttons, and user input may include hitting a button. Likewise, a clear instruction may include hitting another button. Alternatively, touch screen or audio operations can be used. in some exemplary embodiments, icons may be shown on these buttons to designate categories; in some exemplary embodiments, these icons may be dynamic and may, for example, be corporate logos or other designations of a place of interest, which may be based on some priority criteria. For example, a corporation or other owner of a place of interest may have to pay a certain amount to have their logo listed as a category symbol.

In some exemplary embodiments, places of interest may include restaurants, shops, theaters, or any other places of interest such as may be desired.

In some exemplary embodiments, places of interest may be ranked according to a certain priority, which may be based on, for example, their popularity, the amount of money that they are spending to advertise the place of interest, or any other priority criteria. Places of interest may be selected based on this priority criteria; for example, only the top five or top ten may be shown in some cases. This may be dynamic and may be periodically updated; for example, a random assortment may be chosen each time.

### BRIEF DESCRIPTION OF THE FIGURES

Advantages of embodiments of the present invention will be apparent from the following detailed description of the exemplary embodiments thereof, which description should be considered in conjunction with the accompanying drawings in which like numerals indicate like elements, in which:

FIG. 1 is a front view of an exemplary embodiment of an interactive electronic map display device.

FIG. 2 is a left side view of an exemplary embodiment of an interactive electronic map display device.

FIG. 3 is a right side view of an exemplary embodiment of an interactive electronic map display device.

FIG. 4 is a back and right side isometric view of an exemplary embodiment of an interactive electronic map display device.

FIG. 5 is a front and left side view of an exemplary embodiment of an interactive electronic map display device.

FIG. 6 is an exemplary embodiment of a graphical user interface.

FIG. 7 is an exemplary embodiment of a graphical user interface.

FIG. 8 is an exemplary flowchart depicting an exemplary embodiment of a method for using an interactive electronic map display device.

### DETAILED DESCRIPTION

Aspects of the invention are disclosed in the following description and related drawings directed to specific embodiments of the invention. Alternate embodiments may be devised without departing from the spirit or the scope of the invention. Additionally, well-known elements of exemplary embodiments of the invention will not be described in detail or will be omitted so as not to obscure the relevant details of the invention. Further, to facilitate an understanding of the description discussion of several terms used herein follows.

As used herein, the word “exemplary” means “serving as an example, instance or illustration.” The embodiments described herein are not limiting, but rather are exemplary only. It should be understood that the described embodiments are not necessarily to be construed as preferred or advantageous over other embodiments. Moreover, the terms “embodiments of the invention”, “embodiments” or “invention” do not require that all embodiments of the invention include the discussed feature, advantage or mode of operation.

Further, many embodiments are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, these sequence of actions described herein can be considered to be embodied entirely within any form of computer readable storage medium having stored therein a corresponding set of computer instructions that upon execution would cause an associated processor to perform the functionality described herein. Thus, the various aspects of the invention may be embodied in a number of different forms, all of which have been contemplated to be within the scope of the claimed subject matter. In addition, for each of the embodiments described herein, the corresponding form of any such embodiments may be described herein as, for example, “logic configured to” perform the described action.

According to an exemplary embodiment, and referring generally to the Figures, various exemplary implementations of an interactive electronic map may be disclosed. According to some exemplary embodiments, an interactive electronic map may be specifically implemented on a display device, such as a display stand or display kiosk, in order to enhance the readability of the map as compared to a map viewable on a mobile device of a user. According to an exemplary embodiment, such a display stand or display kiosk may be installed at various points around a particular locale (such as, for example, the city of Detroit, or a particular region of the city of Detroit, such as the downtown region) and may be used in order to assist visitors in finding their way or finding directions easily to places that they may want to go. As such, according to some exemplary embodiments, interactive electronic maps may be specifically geared toward providing directions to visitors and may have, as pre-saved locations, certain areas that are popular with visitors to the area. For example, in some exemplary embodiments, if a visitor wants to find the location of a restaurant or shops in a particular area or place, all they will need to do is push a button, and the map will display only restaurants or shops in that locality.

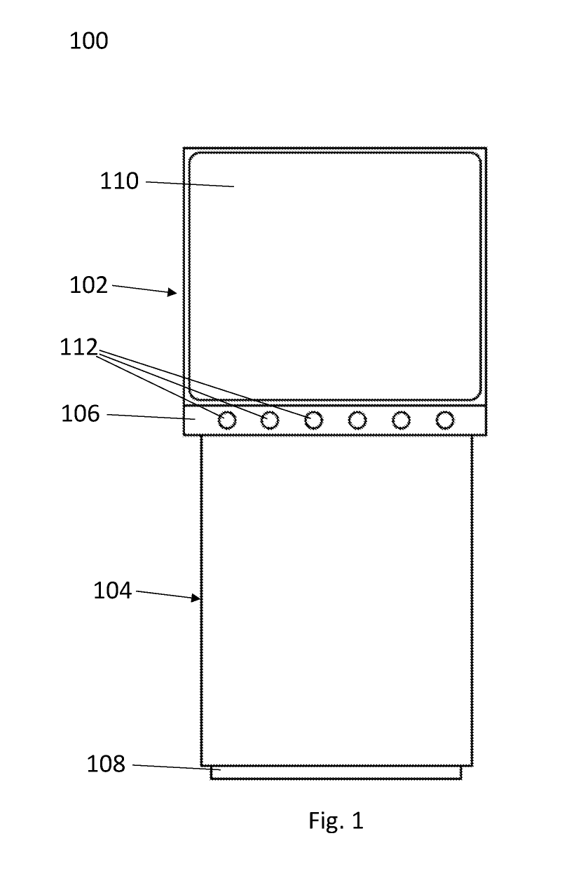

Turning now to exemplary FIG. 1, FIG. 1 displays an exemplary embodiment of an interactive electronic map display device 100. According to an exemplary embodiment, an interactive electronic map display device 100 may have a top portion 102 having a screen 110, a lower portion 104 having a stand 108, and a control portion 106, which may, for example, have a plurality of buttons 112 disposed thereupon. In some other exemplary embodiments, other controls for the interactive electronic map display device 100 may be contemplated, such as, for example, a touch screen controller, an audio controller causing the device to be controlled by the voice of a speaker, or any other such controller such as may be desired.

According to an exemplary embodiment, an interactive electronic map display device 100 may be a rectangular structure having a screen 110 provided on one face of the rectangular structure, which may be used to display the maps. In some exemplary embodiments, the rectangular structure may have a height of approximately five feet, a length of approximately two and a half feet, and a width (or depth) of approximately one and one half feet, with the screen disposed on a face approximately five feet high and two and a half feet long. According to an exemplary embodiment, the screen 110 may be approximately four square feet in area (approximately two feet by two feet, or any other dimensions such as may be desired). This may ensure that the screen 110 of the interactive electronic map display device 100 can be used to show maps that are significantly larger than the maps that can be shown on a mobile device of a user.

According to an exemplary embodiment, each of the buttons of the device 112 may be used to show a different specific place of interest or different specific set of places of interest. For example, according to an exemplary embodiment, button 1 will show only restaurants, button 2 will show shops, button 3 shows theaters, and so on for the remaining buttons. In another exemplary embodiment, button 1 may show a specific restaurant, button 2 may show a specific tourist attraction, and so forth. According to an exemplary embodiment, one button may be labeled “streets” and may be used to show the streets for the locality, whereas other buttons may, when selected, cause only streets relevant to navigation to be shown, if desired.

According to an exemplary embodiment, an interactive electronic map display device 100 may specifically be used for advertisement purposes. For example, after some trigger event is satisfied (such as, for example, when the interactive electronic map display device 100 has not been used for some period of time) the interactive electronic map display device 100 may be configured to show advertisements on the display until the display is interacted with again (such as, for example, if a user is detected as approaching the interactive electronic map display device 100 with a sensor of the interactive electronic map display device 100, or if the user presses a button on the interactive electronic map display device 100). According to an exemplary embodiment, advertisements may be shown in such a manner as to indicate to a viewer that the interactive electronic map display device 100 is a device for viewing maps; for example, according to an exemplary embodiment, advertisements may be shown only on a portion of the screen of the interactive electronic map display device 100, with the map being shown on another portion of the screen, if desired.

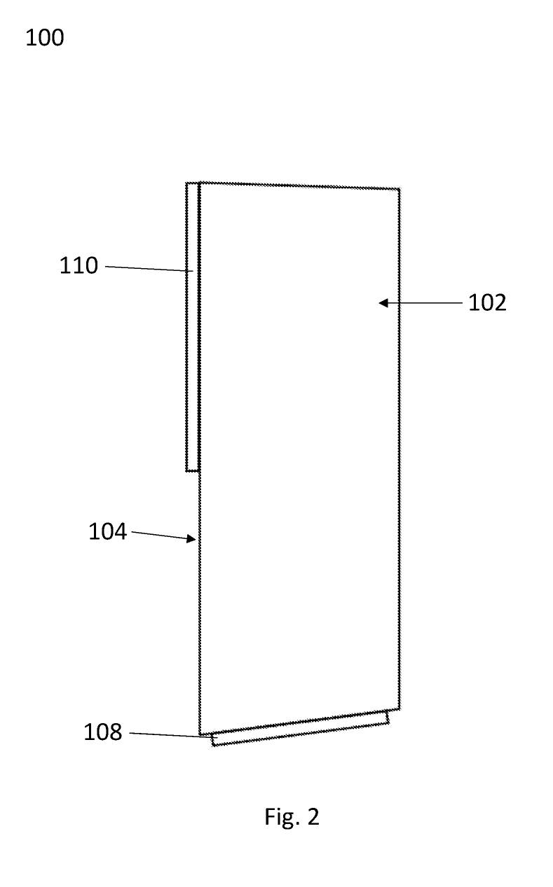

Turning now to exemplary FIG. 2, FIG. 2 shows an exemplary embodiment of an interactive electronic map display device 100 as seen from the side. According to an exemplary embodiment, the interactive electronic map display device 100 may be disposed at an angle, and may, for example, be tilted slightly backward for greater visibility. According to another exemplary embodiment, the interactive electronic map display device 100 may have any other shape such as may be desired.

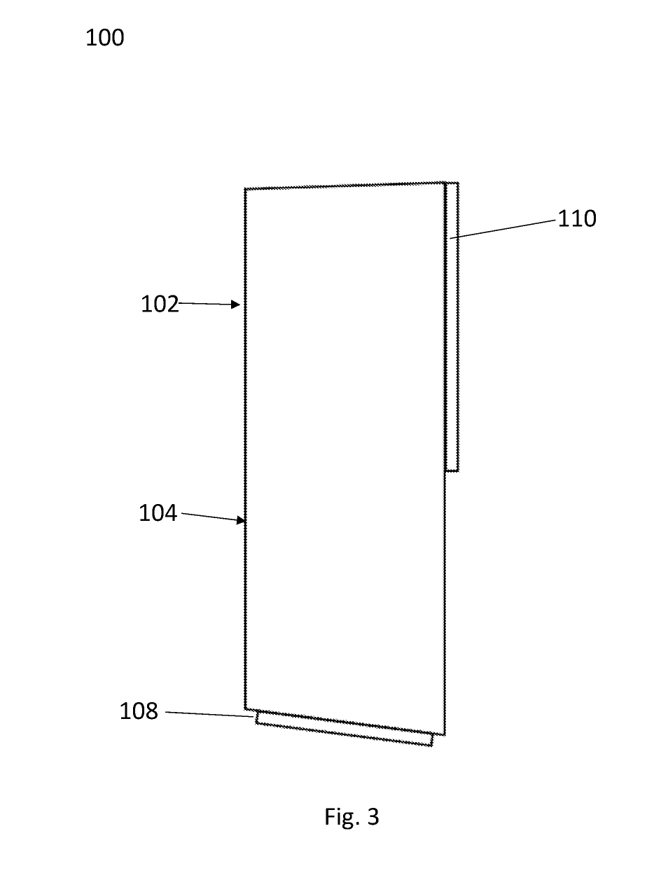

Turning now to exemplary FIG. 3, FIG. 3 shows an exemplary embodiment of an interactive electronic map display device 100 as seen from the opposite side as FIG. 2.

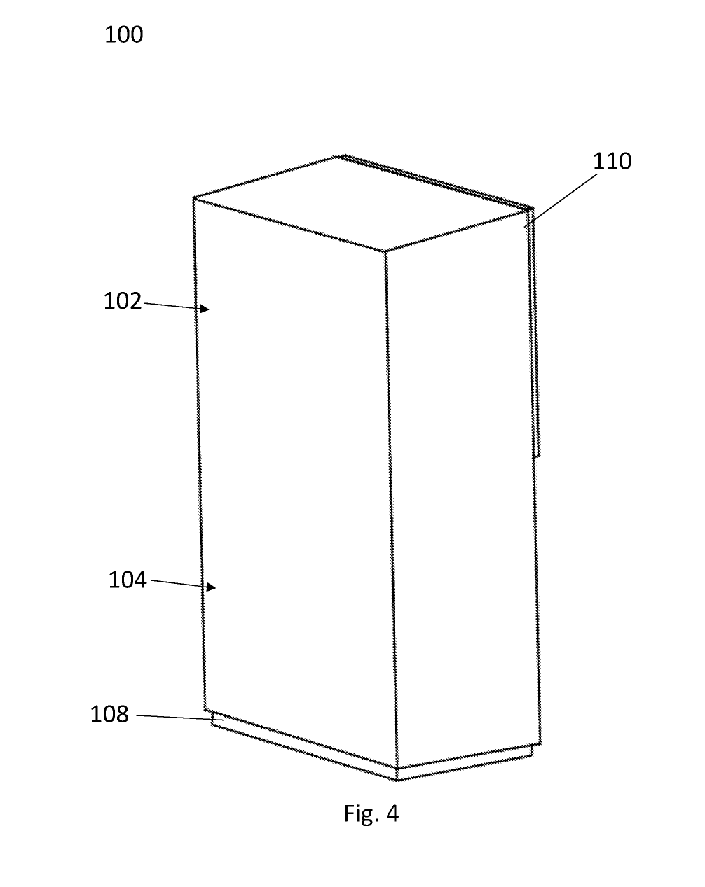

Turning now to exemplary FIG. 4, FIG. 4 shows an exemplary embodiment of an interactive electronic map display device 100 as seen from the back right side.

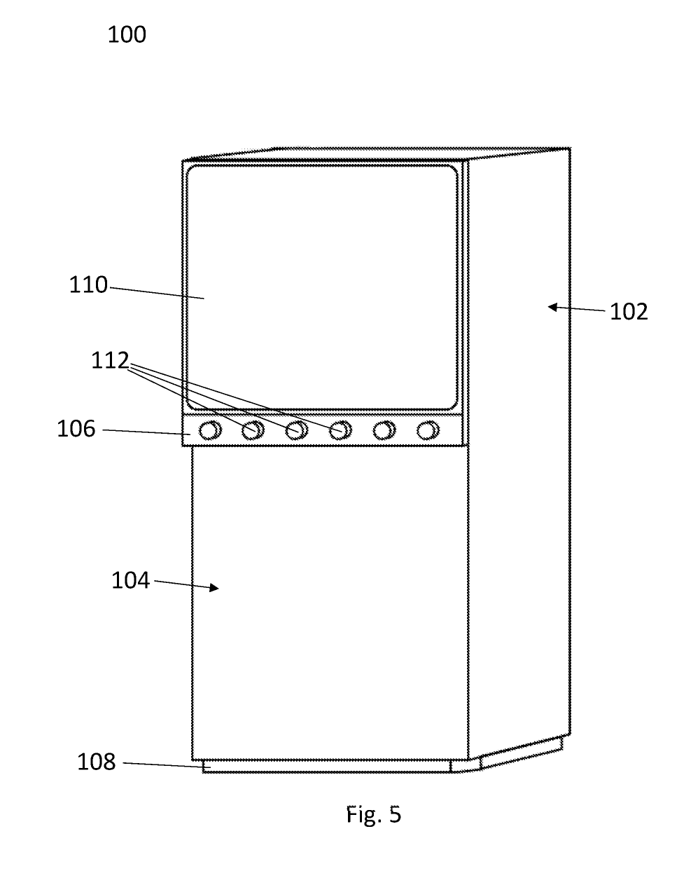

Turning now to exemplary FIG. 5, FIG. 5 shows an exemplary embodiment of an interactive electronic map display device 100 as seen from the front left side. Looking specifically at the stand 108 of the interactive electronic map display device 100, the stand 108 may be distinguishable from the lower portion 104 of the interactive electronic map display device 100, which may, for example, taper into the stand portion 108. According to exemplary embodiment, the stand 108 (as well as any other components of the interactive electronic map display device 100) may have any shape; for example, according to an exemplary embodiment, the corners of the stand 108 may be rounded or may be curved. In some exemplary embodiments, the stand 108 may be rotatable, or may allow the lower portion 104 of the interactive electronic map display device 100 to rotate in order to orient the screen in a favorable direction. (In other exemplary embodiments, any part of the interactive electronic map display device 100 may rotate, if desired.)

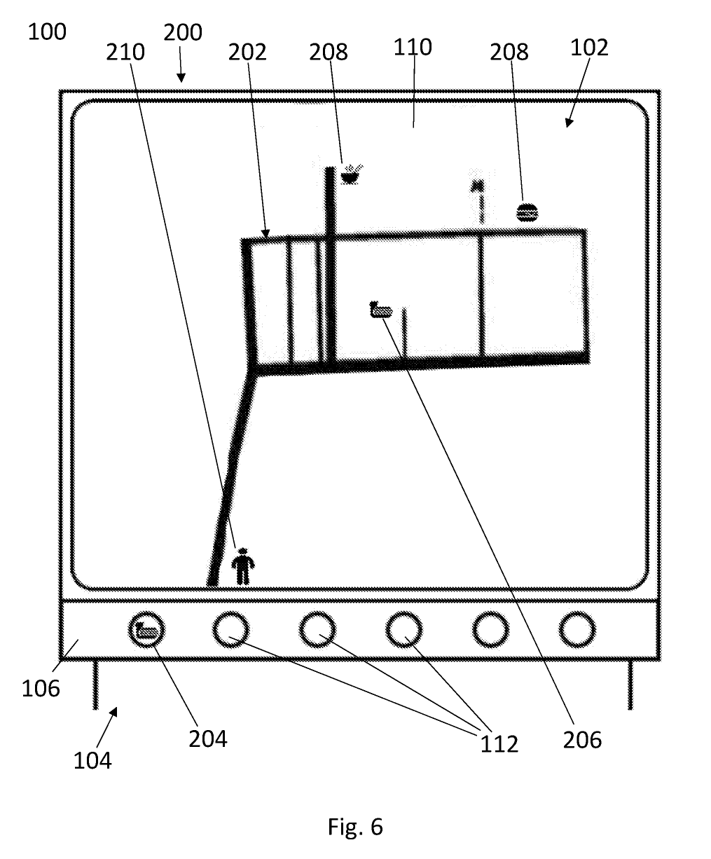

Turning now to exemplary FIG. 6, FIG. 6 shows an exemplary embodiment of a graphical user interface showing a map 200 as displayed on the screen 110 of an interactive electronic map display device 100. According to an exemplary embodiment, when a user presses a first button 204 (which in this case may be labeled “Restaurants”), the map to be displayed 202. may show only restaurants in that locality 206, 208, as well as, in some exemplary embodiments, the streets or paths that may be used in order to reach those restaurants. In an exemplary embodiment, the position of the user 210 may also be clearly displayed on the map 202.

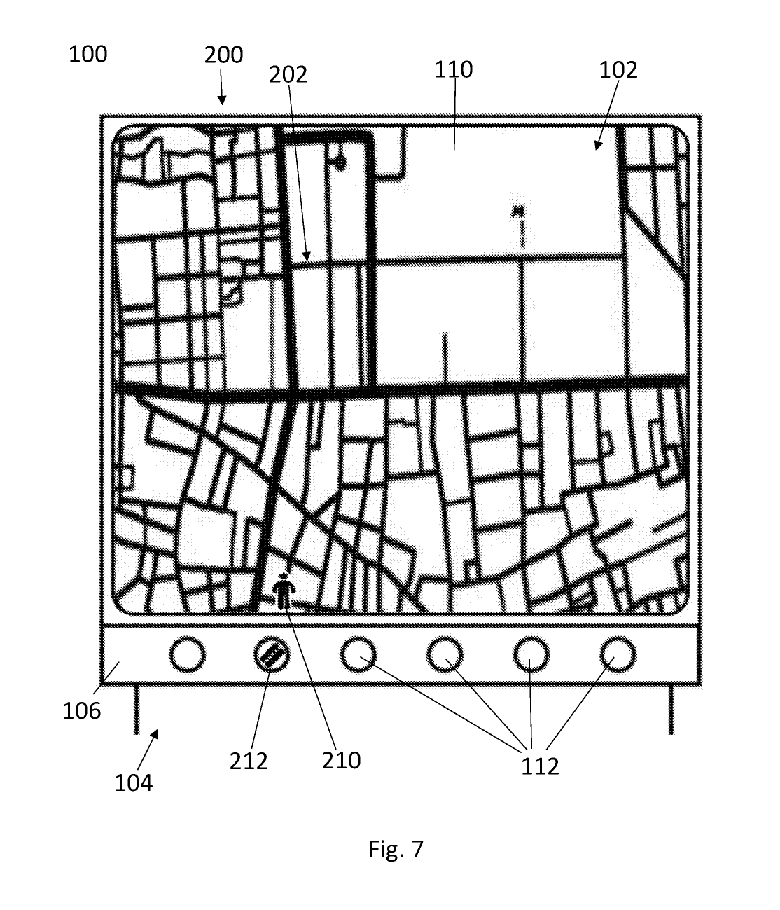

Turning now to exemplary FIG. 7, FIG. 7 shows an exemplary embodiment of a graphical user interface showing a map 200 as displayed on the screen 110 of an interactive electronic map display device 100. In this case, the user may have pressed a second button labeled “Streets” 212, which may be used to show only the streets in the same locality. According to an exemplary embodiment, this second button 212 may show, for example, a greater number of streets, such as side streets or streets not relevant to navigation to a particular place, that may not be shown in other maps, such as restaurant maps. According to another exemplary embodiment, a graphical user interface may display streets on each map (using some other method to more quickly distinguish sites of interest from background noise) and selection of the “streets” button may be used in order to clear other selections.

According to an exemplary embodiment, an interactive electronic map display device 100 may also be used to show directions to the particular locale. For example, according to an exemplary embodiment, if the user selects a first button 204 and selects a restaurant that may be displayed after selecting the first button 204, the interactive electronic map display device 100 may show the user the best routes to take to reach the restaurant. In some exemplary embodiments, these directions may persist as the user transitions from screen to screen by pressing buttons 112, unless cleared by the user; this may allow the user to see the general street layout of the area (which may help them to navigate; for example, they may have an easier time looking for a street on which they will have to turn if they can think of it as, for example, “the third street on the left” instead of “Main Street”), may allow the user to see other places of interest that are on their way (and which the user may wish to stop at), or may allow the user to see other places of interest that are nearby to the selected locale (such as shops that may be near the restaurant).

According to an exemplary embodiment, an interactive electronic map display device 100 may have other configurations, and an interactive electronic map 200 may be shown on other devices, such as may be desired. For example, it may be desirable to show the interactive electronic map 200 on a mobile device (such as a vehicular GPS) in addition to on an interactive electronic map display device 100; the mobile device may show similar information to the interactive electronic map display device 100 or may show different information, such as may be desired.

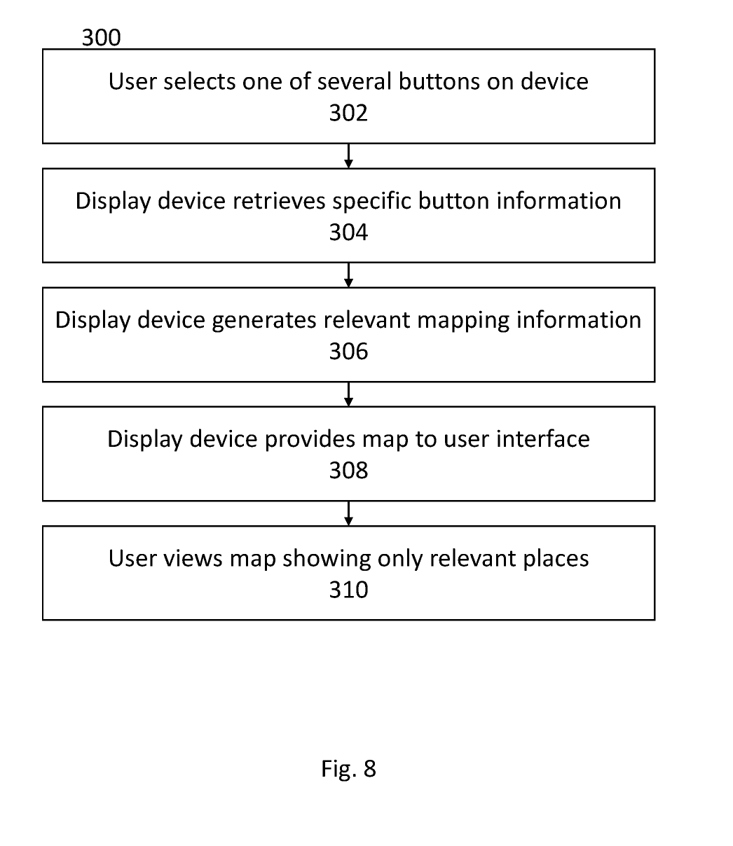

Turning now to exemplary FIG. 8, FIG. 8 shows an exemplary method by which a user can make use of an interactive electronic map display device. In a first step, the user may select one of several buttons on a device 302, which may the be used in order to retrieve the information corresponding to the specific button that the user pressed 304. The display device may then generate relevant mapping information 306, and may output the map 308 to the user interface. The user may thus be able to view a map showing only those places that are relevant to their query 310.

The foregoing description and accompanying figures illustrate the principles, preferred embodiments and modes of operation of the invention. However, the invention should not be construed as being limited to the particular embodiments discussed above. Additional variations of the embodiments discussed above will be appreciated by those skilled in the art (for example, features associated with certain configurations of the invention may instead be associated with any other configurations of the invention, as desired).

Therefore, the above-described embodiments should be regarded as illustrative rather than restrictive. Accordingly, it should be appreciated that variations to those embodiments can be made by those skilled in the art without departing from the scope of the invention as defined by the following claims.

What is claimed is:

1. A computer-implemented method for generating an electronic map displayed in a graphical user interface, the method comprising:
displaying, on a first screen of the graphical user interface, unaltered mapping information, the unaltered mapping information corresponding to a specific area;
storing a plurality of places of interest, each stored place of interest being associated with one or more categories of place of interest, each stored place of interest being located within the specific area;
receiving a user input comprising at least one user selection, the at least one user selection comprising at least one of a selected place of interest or a selected category of places of interest, the at least one user selection further being associated with a user location;
selecting at least one same-category place of interest, the at least one same-category place of interest comprising each of the plurality of stored places of interest sorted into at least one of: a category of the selected place of interest, when the at least one user selection comprises a selected place of interest, or the selected category of places of interest;
selecting navigation information comprising at least one navigable path between the user location and the at least one user selection, and at least one navigable path between the user location and the at least one same-category place of interest; and
displaying, on a second screen of the graphical user interface, altered mapping information consisting of the at least one same category place of interest and the selected navigation information, and removing extraneous mapping information.

2. The method of claim 1, further comprising setting the graphical user interface to a dormant state after a user interaction period, wherein the graphical user interface displays at least one advertisement in the dormant state.

3. The method of claim 2, wherein the step of setting the graphical user interface to a dormant state after the user interaction period comprises one of: waiting for a predefined time period after the user interaction period and setting the graphical user interface to the dormant state if no further interaction is detected in the predefined time period, or detecting, with a sensor, that a user has left, and setting the graphical user interface to the dormant state.

4. The method of claim 2, further comprising:
receiving a plurality of advertisements on the graphical user interface from a server, the plurality of advertisements each having geographic location information associated therewith; and
wherein the graphical user interface displays each of the plurality of advertisements while in the dormant state.

5. The method of claim 4, wherein each of the plurality of advertisements has a priority criterion associated therewith, and wherein the graphical user interface displays each of the plurality of advertisements according to the priority criterion.

6. The method of claim 1, wherein the graphical user interface is implemented on a display device, and wherein the step of receiving a user input comprises detecting an operation of a button on the display device.

7. The method of claim 1, wherein the graphical user interface is implemented on a display device, and wherein the step of receiving a user input comprises one of a touch screen operation or an audio instruction.

8. The method of claim 1, wherein the one or more categories of place of interest comprises the categories of restaurants, shops, and theaters.

9. The method of claim 1, wherein the graphical user interface is implemented on a display device having a plurality of buttons each associated with a button category in the one or more categories of interest, and the method further comprises displaying, on each of the plurality of buttons, an icon corresponding to the button category.

10. The method of claim 1, further comprising automatically returning the graphical user interface to show unaltered mapping information after the user input has been cleared, wherein the user input is cleared following the provision of a clear instruction comprising the operation of a button on the display device.

11. An interactive electronic map display device configured to display a graphical user interface comprising an electronic map, wherein the device is further configured to perform the steps of:
displaying, on a first screen of the graphical user interface, unaltered mapping information, the unaltered mapping information corresponding to a specific area;
storing a plurality of places of interest, each stored place of interest being associated with one or more categories of place of interest, each stored place of interest being located within the specific area;
receiving a user input comprising at least one user selection, the at least one user selection comprising at least one of a selected place of interest or a selected category of places of interest, the at least one user selection further being associated with a user location;
selecting at least one same-category place of interest, the at least one same-category place of interest comprising each of the plurality of stored places of interest sorted into at least one of: a category of the selected place of interest, when the at least one user selection comprises a selected place of interest, or the selected category of places of interest;
selecting navigation information comprising at least one navigable path between the user location and the at least one user selection, and at least one navigable path between the user location and the at least one same-category place of interest; and
displaying, on a second screen of the graphical user interface, altered mapping information consisting of the at least one same category place of interest and the selected navigation information, and removing extraneous mapping information.

12. The device of claim 11, wherein the device is further configured to perform the step of setting the graphical user interface to a dormant state after a user interaction period, wherein the graphical user interface displays at least one advertisement in the dormant state.

13. The device of claim 12, wherein the step of setting the graphical user interface to a dormant state after the user interaction period comprises one of waiting for a predefined time period after the user interaction period and setting the graphical user interface to the dormant state if no further interaction is detected in the predefined time period, or detecting, with a sensor, that a user has left, and setting the graphical user interface to the dormant state.

14. The device of claim 12, wherein the device is further configured to perform the steps of:
receiving a plurality of advertisements on the graphical user interface from a server, the plurality of advertisements each having geographic location information associated therewith; and
wherein the graphical user interface displays each of the plurality of advertisements while in the dormant state.

15. The device of claim 14, wherein each of the plurality of advertisements has a priority criterion associated therewith, and wherein the graphical user interface displays each of the plurality of advertisements according to the priority criterion.

16. The device of claim 11, wherein the device further comprises one or more buttons, and wherein the step of receiving a user input comprises detecting an operation of a button on the device.

17. The device of claim 11, wherein the step of receiving a user input comprises one of a touch screen operation or an audio instruction.

18. The device of claim 11, wherein the one or more categories of place of interest comprises the categories of restaurants, shops, and theaters.

19. The device of claim 1, wherein the device further comprises a plurality of buttons, each associated with a button category in the one or more categories of interest, and the device is further configured to perform the step of displaying, on each of the plurality of buttons, an icon corresponding to the button category.

20. The device of claim 11, wherein the device is further configured to perform the step of automatically returning the graphical user interface to show unaltered mapping information after the user input has been cleared, wherein the user input is cleared following the provision of a clear instruction comprising the operation of a button on the display device.
